(19) United States
(12) Patent Application Publication
(10) Pub. No.: US 2019/0294169 A1
(43) Pub. Date: Sep. 26, 2019

(54) METHOD AND APPARATUS FOR DETECTING A PROXIMATE EMERGENCY VEHICLE

(71) Applicant: GM Global Technology Operations LLC, Detroit, MI (US)

(72) Inventors: Noam R. Shabtai, Be'er-Sheva (IL); Eli Tzirkel-Hancock, Ra'anana (IL); Eilon Riess, Zikron-Yaakov (IL); Shlomo Malka, Ra'anana (IL)

(73) Assignee: GM Global Technology Operations LLC, Detroit, MI (US)

(21) Appl. No.: 15/927,642

(22) Filed: Mar. 21, 2018

(51) Int. Cl. G05D 1/02; G08G 1/04; G08G 1/16

(52) U.S. Cl. CPC G05D 1/0214; G08G 1/166; G08G 1/04; G05D 1/0255

(57) ABSTRACT

A vehicle includes a controller in communication with a plurality of microphones and disposed to dynamically capture signals generated thereby. The controller includes an instruction set that is executable to monitor the signals generated by the plurality of microphones and extract a base frequency therefrom. The extracted base frequency is correlated to one of a plurality of known frequencies, wherein the known frequencies are associated with an acoustic sound being emitted from an emergency vehicle. A direction of arrival of a proximate emergency vehicle relative to the vehicle is determined based upon the signals generated by the plurality of microphones, and operation of the vehicle is controlled based upon the direction of arrival of the proximate emergency vehicle.

### BACKGROUND

Vehicles traversing roadway systems are expected to yield the right-of-way to emergency, first-responder, and other public safety vehicles that are operating with activated sirens and emergency lights. Vehicle operators and autonomously-controlled vehicles may lack knowledge of a location and trajectory of such a vehicle. Vehicle spatial monitoring systems that employ lidar, radar and/or cameras may not be capable of discerning a location and/or trajectory of such public safety vehicles due to intervening occlusions such as buildings and intermediate cars. As such, a vehicle may not yield the right-of-way as quickly as necessary, and thus obstruct a travel path and delay a response capability of a public safety vehicle.

### SUMMARY

A vehicle is described and includes a plurality of microphones disposed thereon. A controller is in communication with each of the microphones and is disposed to dynamically capture signals generated by the plurality of microphones. The controller includes an instruction set that is executable to monitor the signals generated by the plurality of microphones and extract a base frequency therefrom. The extracted base frequency is correlated to one of a plurality of known frequencies, wherein the known frequencies are associated with an acoustic sound being emitted from an emergency vehicle. A direction of arrival of a proximate emergency vehicle relative to the vehicle is determined based upon the signals generated by the plurality of microphones, and operation of the vehicle is controlled based upon the direction of arrival of the proximate emergency vehicle.

An aspect of the disclosure includes the microphones being disposed on an external surface of the vehicle.

Another aspect of the disclosure includes the microphones being disposed in a predefined arrangement relative to the vehicle.

Another aspect of the disclosure includes the microphones being disposed on the external surface of the vehicle and including individual shields that are disposed to deflect ambient environmental conditions, wherein the individual shields are arranged to preserve relative phase information between the microphones.

Another aspect of the disclosure includes a spatial monitoring system disposed to monitor a remote area proximate to the vehicle, including being disposed to determine a location of the proximate emergency vehicle based upon the determined direction of arrival of the emergency vehicle relative to the vehicle and information from the spatial monitoring system, and being disposed to control operation of the vehicle based upon the direction of arrival of the proximate emergency vehicle and the location of the proximate emergency vehicle.

Another aspect of the disclosure includes the vehicle further including an autonomous operating system disposed to control operation of the vehicle, wherein the autonomous operating system is controlled based upon the direction of arrival of the proximate emergency vehicle and the location of the proximate emergency vehicle.

Another aspect of the disclosure includes each of the microphones including a MEMS device that is disposed to generate a pulse-density modulated (PDM) signal in response to the incident acoustic signal.

Another aspect of the disclosure includes the signals generated by the plurality of microphones being subjected to a modified multiple signal classification routine to determine the direction of arrival of the proximate emergency vehicle relative to the vehicle.

Another aspect of the disclosure includes the modified multiple signal classification routine including a plurality of relative transfer functions (RTFs) to determine the direction of arrival of the proximate emergency vehicle relative to the vehicle.

Another aspect of the disclosure includes the RTFs being free-field RTFs that are executed as an algorithm in the controller.

Another aspect of the disclosure includes the RTFs being measured RTFs that are predetermined and stored in a memory device that is in communication with the controller.

The above features and advantages, and other features and advantages, of the present teachings are readily apparent from the following detailed description of some of the best modes and other embodiments for carrying out the present teachings, as defined in the appended claims, when taken in connection with the accompanying drawings.

### BRIEF DESCRIPTION OF THE DRAWINGS

One or more embodiments will now be described, by way of example, with reference to the accompanying drawings.

FIGS. 1-1 and 1-2 schematically illustrate a top plan view of a vehicle including a plurality of microphones disposed thereon, in accordance with the disclosure; and

FIGS. 2, 3 and 4 schematically illustrate details related to an incident sound direction detection routine, in accordance with the disclosure.

### DETAILED DESCRIPTION

The components of the disclosed embodiments, as described and illustrated herein, may be arranged and designed in a variety of different configurations. Thus, the following detailed description is not intended to limit the scope of the disclosure, as claimed, but is merely representative of possible embodiments thereof. In addition, while numerous specific details are set forth in the following description in order to provide a thorough understanding of the embodiments disclosed herein, some embodiments can be practiced without some of these details. Moreover, for the purpose of clarity, certain technical material that is understood in the related art has not been described in detail in order to avoid unnecessarily obscuring the disclosure.

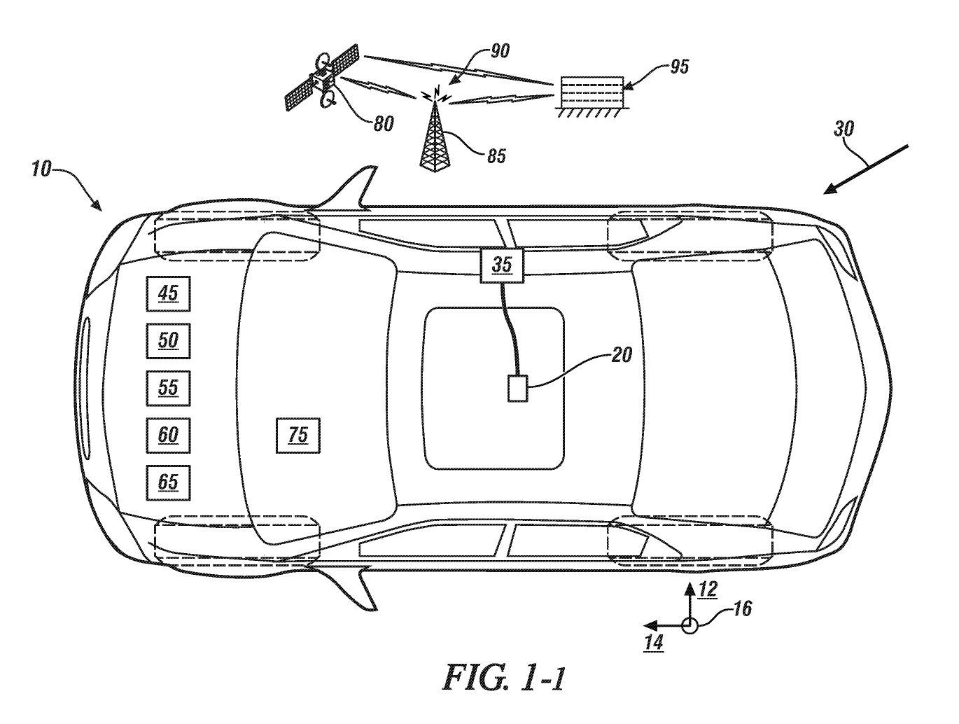

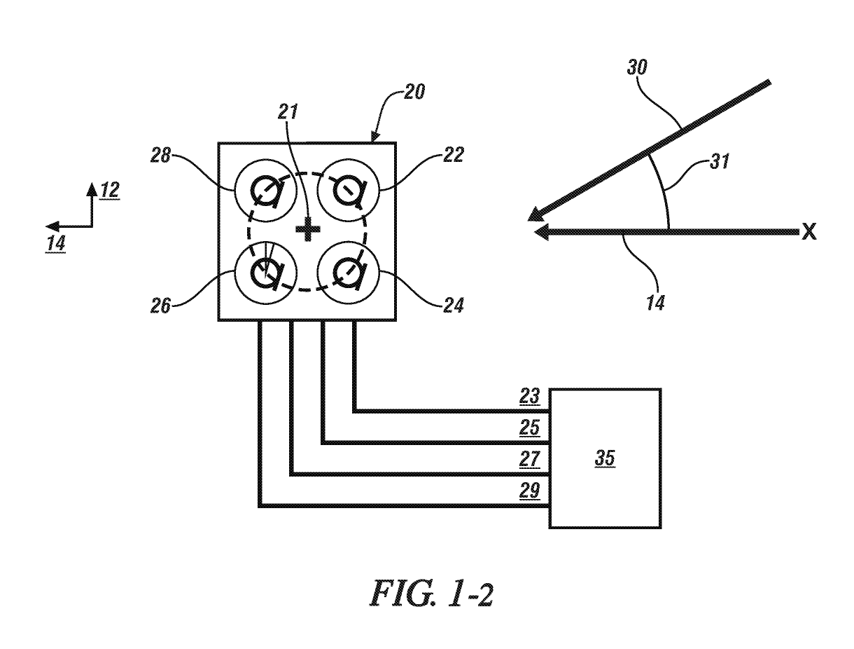

Referring now to the drawings, wherein the showings are for the purpose of illustrating certain exemplary embodiments only and not for the purpose of limiting the same, FIGS. 1-1 and 1-2 schematically show an embodiment of a vehicle 10 that advantageously includes a plurality of microphones that can be disposed in an acoustic microphone array 20. In one embodiment, the vehicle 10 is configured with an autonomous operating system 45 that is disposed to provide a level of autonomous vehicle operation. In one embodiment and as described herein, the vehicle 10 includes a Global Position System (GPS) sensor 50, a navigation system 55, a telematics device 60, a spatial monitoring system 65, a human-machine interface (HMI) system 75, and one or more controllers.

The microphone array 20 includes a plurality of discrete microphones having sensing elements that may be disposed on a common plane and are circumferentially arranged at equivalent angles at a common radial distance from a center point 21, which is located on the vehicle 10 at a predefined location. In one embodiment, the microphone array 20 is composed of four microphones that are disposed in a unitary package and indicated by numerals 22, 24, 26 and 28. Alternatively, there may be 6, 8, 10, 12 or another quantity of microphones arranged as described. Alternatively, the microphones 22, 24, 26 and 28 may be individually packaged devices that are disposed on the vehicle 10 in predefined locations in a manner that is described herein. The microphone array 20 is disposed on an exterior portion of a roof of the vehicle 10 in a relatively unobstructed location in one embodiment. Alternatively, the microphone array 20 may be disposed at another location on an exterior surface of the vehicle 10 or at a location that is interior to the vehicle, so long as the vehicle body does not obstruct or impede the microphones of the microphone array 20 from receiving incident acoustic signals. The concepts described herein may be employed with a suitable quantity of microphones and arrangement of the microphones so long as phase differences in received incident acoustic signals 30 can be consistently characterized and quantified for a range of ambient sound/noise conditions.

The center point 21 and the microphones 22, 24, 26 and 28 of the microphone array 20 each has a predefined XY location relative to the vehicle 10, wherein the X location is defined with reference to a lateral axis 12 of the vehicle 10 and the Y location is defined with reference to a longitudinal axis 14 of the vehicle 10. An altitude axis Z 16 is also indicated. The longitudinal axis 14 is defined to be the direction of travel of the vehicle 10. As such, the lateral and longitudinal axes 12, 14 of the vehicle 10 define the common plane on which the microphones 22, 24, 26 and 28 are disposed. Each of the microphones 22, 24, 26 and 28 is an omnidirectional device having a port angle that is arranged to minimize wind impact when the vehicle 10 is moving in a forward direction of travel in one embodiment. Alternatively, the microphones 22, 24, 26, and 28 have a common directivity that is known and accommodated in software, e.g., in an incident sound direction detection routine 200 described herein. Each of the microphones 22, 24, 26 and 28 can be individually shielded from ambient conditions of rain, wind, etc., such that phase modification of an incident acoustic signal that is induced by the respective shield is consistent between all of the microphones 22, 24, 26 and 28. Therefore, phase differences are invariant to the package of the microphone array 20. Such arrangements maintain the phase differences in incident acoustic signals 30 that are received by the microphones 22, 24, 26 and 28 that are associated with Direction Of Arrival (DOA). The incident acoustic 30 is indicated by an arrow having an incident angle θᵢ 31 that is defined in relation to the longitudinal axis 14 and may correspond to a direction of arrival of the emergency vehicle.

In one embodiment, each of the microphones 22, 24, 26 and 28 is a Micro Electro-Mechanical System, or MEMS microphone. A MEMS microphone is arranged as a microphone on a silicon wafer, wherein a pressure-sensitive membrane is etched directly onto the silicon wafer with a matched pre-amplifier and an integrated analog/digital converter. As such, the microphones 22, 24, 26 and 28 are digital microphones that have respective digital signal outputs 23, 25, 27 and 29. The digital signal outputs 23, 25, 27 and 29 are Pulse Density Modulated (PDM) outputs that correlate to the incident acoustic signal.

The terms controller, control module, module, control, control unit, processor and similar terms refer to various combinations of Application Specific Integrated Circuit(s) (ASIC), electronic circuit(s), central processing unit(s), e.g., microprocessor(s) and associated non-transitory memory component in the form of memory and storage devices (read only, programmable read only, random access, hard drive, etc.). The non-transitory memory component is capable of storing machine readable instructions in the form of one or more software or firmware programs or routines, combinational logic circuit(s), input/output circuit(s) and devices, signal conditioning and buffer circuitry and other components that can be accessed by one or more processors to provide a described functionality. Input/output circuit(s) and devices include analog/digital converters and related devices that monitor inputs from sensors, with such inputs monitored at a preset sampling frequency or in response to a triggering event. Software, firmware, programs, instructions, control routines, code, algorithms and similar terms mean controller-executable instruction sets including calibrations and look-up tables. Each controller executes control routine(s) to provide desired functions, including monitoring inputs from sensing devices and other networked controllers and executing control and diagnostic routines to control operation of actuators. Routines may be periodically executed at regular intervals, or may be executed in response to occurrence of a triggering event. Communication between controllers, and communication between controllers, actuators and/or sensors may be accomplished using a direct wired link, a networked communications bus link, a wireless link, a serial peripheral interface bus or another suitable communications link. Communication includes exchanging data signals in suitable form, including, for example, electrical signals via a conductive medium, electromagnetic signals via air, optical signals via optical waveguides, and the like. Data signals may include signals representing inputs from sensors, signals representing actuator commands, and communications signals between controllers.

The term ‘model’ refers to a processor-based or processor-executable code and associated calibration that simulates a physical existence of a device or a physical process. As used herein, the terms ‘dynamic’ and ‘dynamically’ describe steps or processes that are executed in real-time and are characterized by monitoring or otherwise determining states of parameters and regularly or periodically updating the states of the parameters during execution of a routine or between iterations of execution of the routine. The terms “calibration”, “calibrate”, and related terms refer to a result or a process that compares an actual or standard measurement associated with a device with a perceived or observed measurement or a commanded position. A calibration as described herein can be reduced to a storable parametric table, an array of parameters, a plurality of executable equations, or another suitable form. A parameter is defined as a measurable quantity that represents a physical property of a device or other element that is discernible using one or more sensors and/or a physical model. A parameter can have a discrete value, e.g., either “1” or “0”, or can be infinitely variable in value.

The vehicle 10 includes a telematics device 60, which includes a wireless telematics communication system capable of extra-vehicle communications, including communicating with a communication network system having wireless and wired communication capabilities. The telematics device 60 is capable of extra-vehicle communications that includes short-range vehicle-to-vehicle (V2V) communication and/or vehicle-to-infrastructure (V2x) communication, which may include communication with an infrastructure monitor, e.g., a traffic camera. Alternatively or in addition, the telematics device 60 has a wireless telematics communication system capable of short-range wireless communication to a handheld device, e.g., a cell phone, a satellite phone or another telephonic device. In one embodiment the handheld device is loaded with a software application that includes a wireless protocol to communicate with the telematics device 60, and the handheld device executes the extra-vehicle communication, including communicating with an off-board controller 95 via a communication network 90 including a satellite 80, an antenna 85, and/or another communication mode. Alternatively or in addition, the telematics device 60 executes the extra-vehicle communication directly by communicating with the off-board controller 95 via the communication network 90.

The vehicle spatial monitoring system 65 includes a spatial monitoring controller in communication with a plurality of sensing devices. The vehicle spatial monitoring system 65 dynamically monitors an area proximate to the vehicle 10 and generates digital representations of observed or otherwise discerned remote objects. The spatial monitoring system 65 can determine a linear range, relative speed, and trajectory of each proximate remote object. The sensing devices of the spatial monitoring system 65 may include, by way of non-limiting descriptions, front corner sensors, rear corner sensors, rear side sensors, side sensors, a front radar sensor, and a camera in one embodiment, although the disclosure is not so limited. Placement of the aforementioned sensors permits the spatial monitoring system 65 to monitor traffic flow including proximate vehicles and other objects around the vehicle 10. Data generated by the spatial monitoring system 65 may be employed by a lane mark detection processor (not shown) to estimate the roadway. The sensing devices of the vehicle spatial monitoring system 65 can further include object-locating sensing devices including range sensors, such as FM-CW (Frequency Modulated Continuous Wave) radars, pulse and FSK (Frequency Shift Keying) radars, and Lidar (Light Detection and Ranging) devices, and ultrasonic devices which rely upon effects such as Doppler-effect measurements to locate forward objects. The possible object-locating devices include charged-coupled devices (CCD) or complementary metal oxide semi-conductor (CMOS) video image sensors, and other camera/video image processors which utilize digital photographic methods to ‘view’ forward and/or rear objects including one or more object vehicle(s). Such sensing systems are employed for detecting and locating objects in automotive applications and are useable with autonomous operating systems including, e.g., adaptive cruise control, autonomous braking, autonomous steering and side-object detection.

The sensing devices associated with the spatial monitoring system 65 are preferably positioned within the vehicle 10 in relatively unobstructed positions. Each of these sensors provides an estimate of actual location or condition of an object, wherein said estimate includes an estimated position and standard deviation. As such, sensory detection and measurement of object locations and conditions are typically referred to as ‘estimates.’ The characteristics of these sensors may be complementary in that some may be more reliable in estimating certain parameters than others. The sensing devices may have different operating ranges and angular coverages capable of estimating different parameters within their operating ranges. For example, radar sensors may estimate range, range rate and azimuth location of an object, but are not normally robust in estimating the extent of a detected object. A camera with vision processor is more robust in estimating a shape and azimuth position of the object, but may be less efficient at estimating the range and range rate of an object. Scanning type lidar sensors perform efficiently and accurately with respect to estimating range, and azimuth position, but typically cannot estimate range rate, and therefore may not be as accurate with respect to new object acquisition/recognition. Ultrasonic sensors are capable of estimating range but may be less capable of estimating or computing range rate and azimuth position. The performance of each of the aforementioned sensor technologies is affected by differing environmental conditions. Thus, some of the sensing devices may present parametric variances during operation, although overlapping coverage areas of the sensors create opportunities for sensor data fusion. Sensor data fusion includes combining sensory data or data derived from sensory data from various sources that are observing a common field of view such that the resulting information is more accurate and precise than would be possible when these sources are used individually.

The HMI system 75 provides for human/machine interaction, for purposes of directing operation of an infotainment system, the GPS sensor 50, the vehicle navigation system, a remotely located service center and the like. The HMI system 75 monitors operator requests and provides information to the operator including status of vehicle systems, service and maintenance information. The HMI system 75 communicates with and/or controls operation of a plurality of in-vehicle operator interface device(s). The HMI system 75 may also communicate with one or more devices that monitor biometric data associated with the vehicle operator, including, e.g., eye gaze location, posture, and head position tracking, among others. The HMI system 75 is depicted as a unitary device for ease of description, but may be configured as a plurality of controllers and associated sensing devices in an embodiment of the system described herein. The in-vehicle operator interface device(s) can include devices that are capable of transmitting a message urging operator action, and can include an electronic visual display module, e.g., a liquid crystal display (LCD) device, a heads-up display (HUD), an audio feedback device, a wearable device and a haptic seat.

The vehicle 10 can include an autonomous operating system 45 that is disposed to provide a level of autonomous vehicle operation. The autonomous operating system 45 includes a controller and one or a plurality of subsystems that may include an autonomous steering system, an adaptive cruise control system, an autonomous braking/collision avoidance system and/or other systems that are configured to command and control autonomous vehicle operation separate from or in conjunction with operator requests. Autonomous operating commands may be generated to control the autonomous steering system the adaptive cruise control system, the autonomous braking/collision avoidance system and/or the other systems. Vehicle operation includes operation in one of the propulsion modes in response to desired commands, which can include operator requests and/or autonomous vehicle requests. Vehicle operation, including autonomous vehicle operation includes acceleration, braking, steering, steady-state running, coasting, and idling. Operator requests can be generated based upon operator inputs to an accelerator pedal, a brake pedal, a steering wheel, a transmission range selector, and a cruise control system. Vehicle acceleration includes a tip-in event, which is a request to increase vehicle speed, i.e., accelerate the vehicle. A tip-in event can originate as an operator request for acceleration or as an autonomous vehicle request for acceleration. One non-limiting example of an autonomous vehicle request for acceleration can occur when a sensor for an adaptive cruise control system indicates that a vehicle can achieve a desired vehicle speed because an obstruction has been removed from a lane of travel, such as may occur when a slow-moving vehicle exits from a limited access highway. Braking includes an operator request to decrease vehicle speed. Steady-state running includes vehicle operation wherein the vehicle is presently moving at a rate of speed with no operator request for either braking or accelerating, with the vehicle speed determined based upon the present vehicle speed and vehicle momentum, vehicle wind resistance and rolling resistance, and driveline inertial drag, or drag torque. Coasting includes vehicle operation wherein vehicle speed is above a minimum threshold speed and the operator request to the accelerator pedal is at a point that is less than required to maintain the present vehicle speed. Idle includes vehicle operation wherein vehicle speed is at or near zero. The autonomous operating system 45 includes an instruction set that is executable to determine a trajectory for the vehicle 10, and determine present and/or impending road conditions and traffic conditions based upon the trajectory for the vehicle 10.

FIGS. 2, 3 and 4 schematically show details related to an incident sound direction detection routine 200 that is executed as algorithmic code that is stored as instructions and calibrations in an on-board controller, e.g., controller 35. The incident sound direction detection routine 200 is exhibited as a flowchart, wherein the numerically labeled blocks and the corresponding functions are set forth as described herein. The teachings may be described in terms of functional and/or logical block components and/or various processing steps. It should be realized that such block components may be composed of hardware, software, and/or firmware components that have been configured to perform the specified functions. The steps of the incident sound direction detection routine 200 may be executed in a suitable order, and are not limited to the order described with reference to FIG. 2.

The incident sound direction detection routine 200 includes an extract base frequency routine 210, a match signature routine 220, a signal classification routine 230, a signal fusion routine 240, and a databank 250. The extract base frequency routine 210, match signature routine 220, signal classification routine 230, and signal fusion routine 240 execute to dynamically evaluate ambient noise that is captured by the digital microphones 22, 24, 26 and 28 to determine a direction of arrival of a source of an incident acoustic signal 30 in relation to the vehicle 10, employing information that is stored in the databank 250 that can be interrogated by the match signature routine 220 and the signal classification routine 230.

The direction of arrival of the source of an incident acoustic signal 30 corresponds to θᵢ, i.e., the incident angle 31 of the incident acoustic signal 30. The incident acoustic signal 30 may indicate that an emergency vehicle emitting an audible siren is in the proximity of the vehicle 10. The incident sound direction detection routine 200 dynamically evaluates the incident acoustic signal 30 to determine the direction of arrival of the source of the incident acoustic signal 30 in relation to the vehicle 10. Upon determining that the incident acoustic signal 30 is of interest to the vehicle operator because it indicates proximity of an emergency vehicle, the incident sound direction detection routine 200 provides information to the vehicle operator and/or the autonomous operating system 45 that indicates a desired course of action for the vehicle 10 to avoid the source of the incident acoustic signal 30, i.e., to avoid obstructing a travel path of the proximate emergency vehicle.

The extract base frequency routine 210 includes monitoring the digital signal outputs 23, 25, 27 and 29 from the respective digital microphones 22, 24, 26 and 28, including capturing the PDM signals from the plurality of microphones in one embodiment. The extract base frequency routine 210 captures a base acoustic frequency 215 and related harmonic frequencies from the digital signal outputs 23, 25, 27 and 29 by applying a Fast-Fourier Transform (FFT) analysis or another analytical process. The base acoustic frequency 215 can be a single frequency, a harmonic of the single frequency, a frequency range, or acoustic noise in one embodiment.

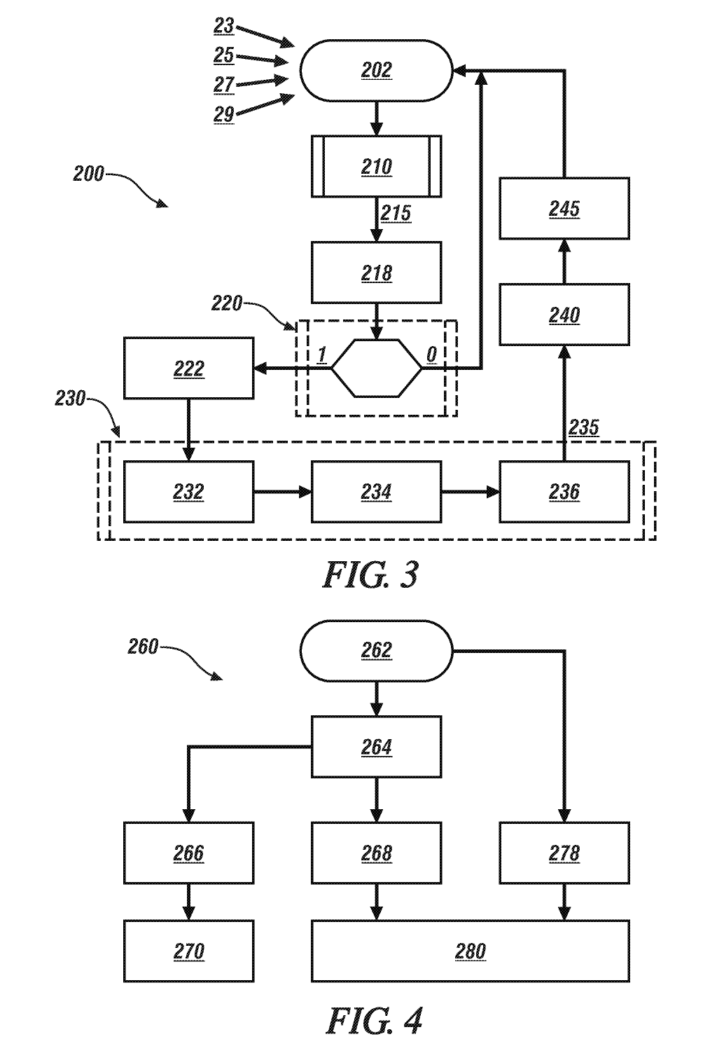

The match signature routine 220 employs information from the databank 250, which includes a pre-training routine 260 to develop the data contents for a vehicle signature frequency memory bank 270 and an array Relative Transfer Function (RTF) memory bank 280. The pre-training routine 260 is described in detail with reference to FIG. 4.

The match signature routine 220 compares the base acoustic frequency 215 with each of a plurality of vehicle acoustic signatures 275 to determine whether the base acoustic frequency 215 corresponds to one of the plurality of vehicle acoustic signatures 275. The vehicle acoustic signatures 275 are predetermined and stored as data in the vehicle signature frequency memory bank 270. When the base acoustic frequency 215 of the signal outputs 23, 25, 27 and 29 corresponds to one of the plurality of vehicle acoustic signatures 275, it indicates a need to detect a direction of the source of the incident acoustic signal 30, and the incident sound direction detection routine 200 proceeds to the next step.

The signal classification routine 230 employs a set of Relative Transfer Functions (RTFs) 285 to determine a direction of arrival 235 for the source of the incident acoustic signal 30. The RTFs 285 can be predetermined and stored as data in the array RTF memory bank 280. The RTFs 285 can include a plurality of pre-measured RTFs that have been calculated for each angle of rotation associated with a possible direction of arrival 235 of the incident acoustic signal 30, and ranges from 0 degrees to 360 degrees and stored in a memory device that can be accessed by the controller 35. Alternatively or in addition, the RTFs can include free-field RTFs that are dynamically calculated for a direction of arrival 235 of the incident acoustic signal 30.

The direction of arrival 235 of the incident acoustic signal 30 is input to the signal fusion routine 240, which evaluates it in conjunction with signal information from other on-vehicle sensors to determine a final direction of arrival 245 that is associated with the source of the incident acoustic signal 30 in relation to the vehicle 10. The other on-vehicle sensors include the sensing devices of the vehicle spatial monitoring system 65, e.g., lidar, radar, on-board cameras, and the GPS sensor 50. The final direction of arrival 245 can be defined as a direction of arrival of the source of the incident acoustic signal 30 in relation to the vehicle 10, and is preferably referenced to the XYZ axes of the vehicle 10. In one embodiment, information related to elevation as defined on the Z axis can be employed to better understand the final direction of arrival 245 related to a curved path and/or path having changing elevations that may occur, and assists in determining whether the source of the sound, i.e. the emergency vehicle has a final direction of arrival 245 that is fore or aft in an uphill/downhill path. The fused vehicle information can be employed to determine a location, orientation and trajectory of the emergency vehicle, and operation of the vehicle 10 can be controlled and/or commanded based upon the location, orientation and trajectory of the emergency vehicle.

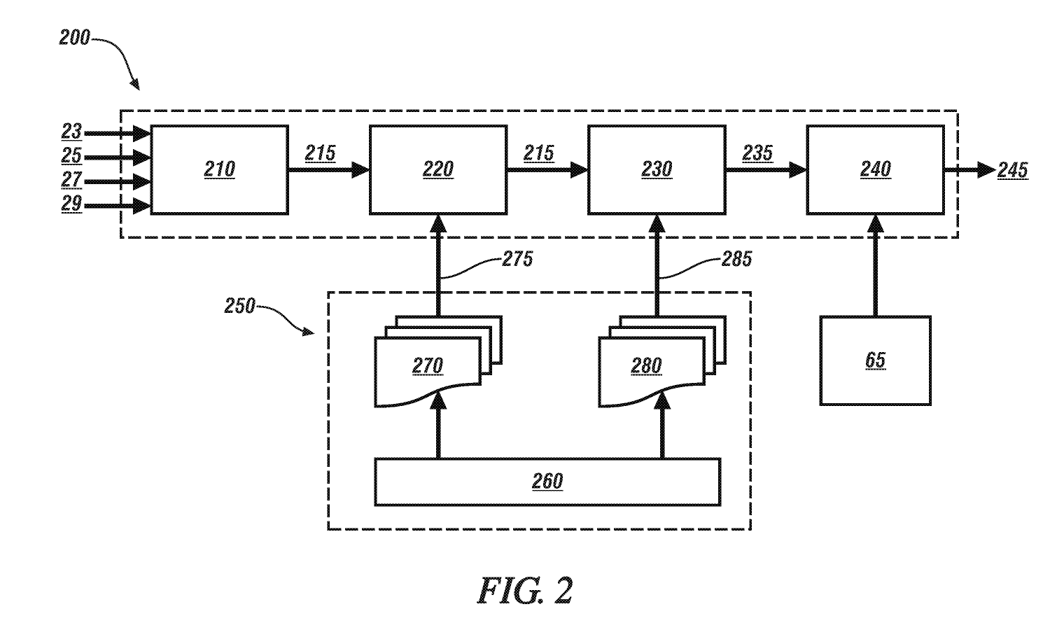

FIG. 3 schematically shows additional details with regard to operation of the incident sound direction detection routine 200. The digital signal outputs 23, 25, 27 and 29 from the respective digital microphones 22, 24, 26 and 28 are captured (202) and are provided to the extract base frequency routine 210 to determine the base acoustic frequency 215 and related harmonic frequencies from the digital signal outputs 23, 25, 27 and 29 employing FFT analysis. The captured base acoustic frequency 215 is presented to the match signature routine 220 (218) for evaluation to determine whether the base acoustic frequency 215 corresponds to one of the plurality of vehicle acoustic signatures 275, which are stored as data in the vehicle signature frequency memory bank 270. When the base acoustic frequency 215 of the signal outputs 23, 25, 27 and 29 fails to correspond to one of the plurality of vehicle acoustic signatures 275 (220)(0), this iteration ends without further action. When the base acoustic frequency 215 of the signal outputs 23, 25, 27 and 29 corresponds to one of the plurality of vehicle acoustic signatures 275 (220)(1), the base acoustic frequency 215 is presented for review by the signal classification routine 230 (222).

FIG. 4 schematically shows a pre-training routine 260 for developing data for storage in and retrieval from the databank 250, including a vehicle signature frequency memory bank 270 and an array RTF memory bank 280. The data contents of the vehicle signature frequency memory bank 270 and the array RTF memory bank 280, are stored in a memory device of the controller 35 for interrogation during dynamic vehicle operation as part of the incident sound direction detection routine 200. Initially, the pre-training routine 260 includes defining a desired angular resolution for the Direction Of Arrival (DOA) (262) which may be a value of 5 degrees of rotation, 10 degrees of rotation or another selected angle of rotation from a zero vector that may be aligned with either the X axis or the Y axis of the vehicle 10. A subject vehicle is configured in a manner consistent with the vehicle 10, including having the microphone array 20 disposed on an exterior portion of a roof of the vehicle 10 with a center point 21 and with the microphones 22, 24, 26 and 28 each having a predefined XY location relative to the center point 21 and the vehicle 10. The subject vehicle is exposed to external sound signals at the zero vector and at selected points of XY rotation from the zero vector that are consistent with the desired angular resolution around 360 degrees of rotation, and data is captured from each of the microphones 22, 24, 26 and 28 for each point in the XY rotation for each external sound signal, corresponding to the DOA (264). At each point of the XY rotation, the external sound signal includes an incident acoustic signal that includes a frequency of interest, e.g., a frequency that is associated with an audible siren that is generated by an emergency vehicle. The frequency of interest may be defined in terms of a minimum/maximum base frequency of the siren signal, which can be matched to known frequency spectrum of sounds generated by specific emergency vehicle sirens with compensation for Doppler-effect and other frequency distortions. Alternatively or in addition, other external sound signals may include frequencies and frequency patterns of interest that can be generated, with data being captured from each of the microphones 22, 24, 26 and 28. Other frequencies and frequency patterns can include a back-up beeper from a sanitation vehicle, a utility vehicle, or a construction vehicle.

A siren model is extracted from the captured data employing an FFT or another frequency spectrum analytical algorithm (266). The siren model is an acoustic signature of audible sound that is representative of the external sound signal that includes the incident acoustic signal that includes the frequency of interest, i.e., an audible siren that is generated by an emergency vehicle. The siren model is captured and stored in the vehicle signature frequency memory bank 270. The acoustic signature is representative of audible sound that is emitted from an emergency vehicle in the form of a siren or other sound.

The captured data is also employed to determine a plurality of RTFs (268), each of which is associated with the DOA when the subject vehicle is exposed to the external sound signal at the zero vector and at selected points of XY rotation from the zero vector that are consistent with the desired angular resolution around 360 degrees of rotation.

An RTF-based steering vector can be defined in the following terms, wherein the incident acoustic signal includes the following terms:

f, which is a frequency of interest, e.g., a frequency associated with an emergency vehicle,

$$c = 343 \frac{m}{s} ,$$

which is the speed of sound,

$$k = \frac{2 π f}{c} ,$$

which is a wave number, and

θᵢ, which is the incident angle 31 of the incident acoustic signal 30, i.e., the final direction of arrival 245 of the emergency vehicle. The speed of sound c is required for calculating the free-field steering vector, and the wave number k is not required for the measured RTFs.

The microphone array, e.g., microphone array 22 can be defined in the following term:

M, which is the total quantity of microphones in the microphone array,

The RTF (relative transfer function) can be defined in the following terms:

Hₘ(f, θᵢ), which is an angular-dependent frequency response,

m_{ref}, which is a reference microphone, and

$${RTF}_{m} ( f , {θ}_{i} ) = \frac{{H}_{m} ( f , {θ}_{i} )}{{H}_{{m}_{ref}} ( f , {θ}_{i} )}$$

wherein RTFₘ_{_{ref}}(f, θᵢ)≡1

The RTF-based steering vector can be determined as follows:

a(f,θᵢ)=[RTF₁(f,θᵢ),RTF₂(f,θᵢ), . . . ,RTF_{M}(f,θᵢ,]^{T} [1]

The angular-dependent RTFs or RTF-based steering vectors are generated at the zero vector and at selected points of XY rotation from the zero vector that are consistent with the desired angular resolution around 360 degrees of rotation for each point in the XY rotation, corresponding to the DOA and stored in the array RTF memory bank 280.

The captured data is also employed to determine a plurality of angular-dependent free-field steering vectors (278), which includes one or a plurality of arriving plane waves that can be defined in the following terms:

f, which is a base frequency,

$$c = 343 \frac{m}{s} ,$$

which is the speed of sound,

$$k = \frac{2 π f}{c} ,$$

which is a wave number, and

θᵢ, which is an incident angle of a respective plane wave, i.e., the final direction of arrival 245 or the direction of arrival of the source of the incident acoustic signal 30 in relation to the vehicle 10.

The microphone array, e.g., microphone array 22 can be defined in the following terms:

M, which is the total quantity of microphones in the microphone array,

rₘ, which is a linear distance of the m^{th} microphone from the center point 21 of the microphone array 22, and

θₘ, which is an angle of the m^{th} microphone from the center point 21 of the microphone array 22.

An angular-dependent free-field steering vector can be expressed as follows:

aₘ(f,θᵢ)=e^{-jkr cos(θ}^{ᵢ}^{-θ}^{ₘ}⁾ [2]

a(f,θᵢ)=[a₁(f,θᵢ),a₂(f,θᵢ), . . . ,a_{M}(f,θᵢ)]^{T} [3]

The angular-dependent free-field steering vectors are generated and stored as data in the array RTF memory bank 280.

The signal classification routine 230 employs the array of Relative Transfer Functions (RTFs) 285 to evaluate the base acoustic frequency 215 to determine the direction of arrival 235 for the source of the incident acoustic signal 30. This includes applying a modified multiple signal classification routine 230, which includes the steps of applying a modified multiple signal detection routine to the incident acoustic signal 30 (232), determining an acoustic direction of arrival of the incident acoustic signal 30 (234), and filtering the acoustic direction of arrival with previously determined values for the acoustic direction of arrival (236) to arrive at the direction of arrival 235.

The Modified mUltiple SIgnal Classification (MUSIC) routine 230 operates in accordance with the following set of relationships.

The MUSIC routine 230 includes the following input signal:

xₘ(t, f), which is the recorded signal at the m^{th} microphone in a Short-Time Fourier Transform (STFT) domain;

The relation can be defined as follows:

x(t,f)=[x₁(t,f),x₂(t,f), . . . ,x_{M}(t,f)]^{T} [4]

wherein θᵢ is estimated from x(t,f).

The MUSIC Spectrum includes the following elements:

θₕ, which is a hypothetical direction of arrival,

Rₓ(t, f)=E[x(t, f)x(t, f)^{H}],

U(t, f)=[u₁(t, f), u₂(t, f), . . . u_{M}(t, f)], which are sorted eigenvectors of R,

D=Number of Eigenvalues over threshold≈No. of sources,

Ũ(t, f)=[u_{D}(t, f), . . . u_{M}(t, f)], which are noise space eigenvectors M×(M−D), and

$$P ( t , f , {θ}_{h} ) = \frac{‖ {a ( f , {θ}_{h} ‖}^{2}}{{a ( f , {θ}_{h} )}^{H} \tilde{U} ( t , f ) {\tilde{U} ( t , f )}^{H} a ( f , {θ}_{h} )} ,$$

which is the MUSIC spectrum.

The MUSIC routine 230 may use the RTFs 285 instead of or in addition to the steering-vector “a” that is normalized to a reference microphone. This is the purpose of combined free-field steering vectors and the measured steering vectors.

The direction of arrival (DOA) 235 is determined as follows:

$${\hat{θ}}_{i} ( t , f ) = arg {max}_{{θ}_{h}} P ( t , f , {θ}_{h} )$$

An acoustic decision identifying an angle associated with the direction of arrival (DOA) can be achieved employing one of the following options: determining the MUSIC spectrum employing the RTF-based steering vector, determining the MUSIC spectrum employing the free-field based steering vector, determining the MUSIC spectrum employing the combined steering vector or a fusion of the RTF-based and free-field based MUSIC spectrum.

The concepts described provide a microphone array and accompanying control routine that are disposed to detect a direction of arrival of an emergency vehicle, along with a control routine that may control the vehicle to avoid obstructing a travel path for the emergency vehicle.

The detailed description and the drawings or figures are supportive and descriptive of the present teachings, but the scope of the present teachings is defined solely by the claims. While some of the best modes and other embodiments for carrying out the present teachings have been described in detail, various alternative designs and embodiments exist for practicing the present teachings defined in the appended claims.

1. A vehicle, comprising:
a plurality of microphones disposed on the vehicle;
a controller, in communication with each of the microphones and disposed to dynamically capture signals generated by the plurality of microphones,
the controller including an instruction set, the instruction set executable to:
monitor the signals generated by the plurality of microphones;
extract a base frequency from the signals generated by the plurality of microphones;
correlate the extracted base frequency to one of a plurality of known frequencies, wherein the known frequencies are associated with an acoustic sound being emitted from an emergency vehicle;
determine a direction of arrival of a proximate emergency vehicle relative to the vehicle based upon the signals generated by the plurality of microphones; and
control operation of the vehicle based upon the direction of arrival of the proximate emergency vehicle.

2. The vehicle of claim 1, wherein the microphones are disposed on an external surface of the vehicle.

3. The vehicle of claim 2, wherein the microphones are disposed in a predefined arrangement relative to the vehicle.

4. The vehicle of claim 2, wherein the microphones disposed on the external surface of the vehicle include individual shields disposed to deflect ambient environmental conditions, wherein the individual shields are arranged to preserve relative phase information between the microphones.

5. The vehicle of claim 1, wherein the vehicle further comprises a spatial monitoring system disposed to monitor a remote area proximate to the vehicle, and wherein the instruction set is executable to:
determine a location of the proximate emergency vehicle based upon the determined direction of arrival of the emergency vehicle relative to the vehicle and information from the spatial monitoring system, and
control operation of the vehicle based upon the direction of arrival of the proximate emergency vehicle and the location of the proximate emergency vehicle.

6. The vehicle of claim 5, wherein the vehicle further comprises an autonomous operating system disposed to control operation of the vehicle, and wherein the instruction set is executable to control the autonomous operating system based upon the direction of arrival of the proximate emergency vehicle and the location of the proximate emergency vehicle.

7. The vehicle of claim 1, wherein each of the microphones comprises a MEMS device disposed to generate a pulse-density modulated (PDM) signal in response to the acoustic sound.

8. The vehicle of claim 1, wherein the instruction set is executable to subject the signals generated by the plurality of microphones to a modified multiple signal classification routine to determine the direction of arrival of the proximate emergency vehicle relative to the vehicle.

9. The vehicle of claim 8, wherein the modified multiple signal classification routine includes a plurality of relative transfer functions (RTFs) to determine the direction of arrival of the proximate emergency vehicle relative to the vehicle.

10. The vehicle of claim 9, wherein the RTFs to determine the direction of arrival of the proximate emergency vehicle relative to the vehicle comprise free-field RTFs.

11. The vehicle of claim 10, wherein the free-field RTFs are executed as an algorithm in the controller.

12. The vehicle of claim 10, wherein the RTFs to determine the direction of arrival of the proximate emergency vehicle relative to the vehicle comprise a plurality of measured RTFs.

13. The vehicle of claim 12, wherein the measured RTFs are predetermined and stored in a memory device that is in communication with the controller.

14. A vehicle, comprising:
a microphone array disposed on the vehicle and including a plurality of microphones;
a controller, in communication with each of the microphones of the microphone array and disposed to dynamically capture signals generated by the plurality of microphones,
the controller including an instruction set, the instruction set executable to:
monitor the signals generated by the plurality of microphones;
extract a base frequency from the signals generated by the plurality of microphones;
correlate the extracted base frequency to one of a plurality of known frequencies, wherein the known frequencies are associated with an acoustic sound being emitted from an emergency vehicle;
subject the signals generated by the plurality of microphones to a modified multiple signal classification routine to determine a direction of arrival of the proximate emergency vehicle relative to the vehicle;
determine a direction of arrival of a proximate emergency vehicle relative to the vehicle based upon the dynamically captured signals generated by the plurality of microphones; and
control operation of the vehicle based upon the direction of arrival of the proximate emergency vehicle.

15. The vehicle of claim 14, wherein the modified multiple signal classification routine includes a plurality of relative transfer functions (RTFs) to determine the direction of arrival of the proximate emergency vehicle relative to the vehicle.

16. The vehicle of claim 15, wherein the RTFs to determine the direction of arrival of the proximate emergency vehicle relative to the vehicle comprise free-field RTFs.

17. The vehicle of claim 15, wherein the RTFs to determine the direction of arrival of the proximate emergency vehicle relative to the vehicle comprise a plurality of measured RTFs.

18. A method for controlling operation of a subject vehicle including a plurality of microphones disposed on an external surface thereof, the method comprising:
dynamically capturing signals generated by the plurality of microphones;
extracting a base frequency from the dynamically captured signals generated by the plurality of microphones;
correlating the extracted base frequency to one of a plurality of known frequencies, wherein the known frequencies are associated with audible sound emitted from an emergency vehicle;
subjecting, via a controller, the dynamically captured signals to a modified multiple signal classification routine to determine a direction of arrival of a proximate emergency vehicle; and
controlling operation of the subject vehicle based upon the direction of arrival of an emergency vehicle proximal to the subject vehicle.

19. The method of claim 18, wherein subjecting the dynamically captured signals to a modified multiple signal classification routine to determine the direction of arrival of the proximate emergency vehicle relative to the subject vehicle comprises subjecting the dynamically captured signals to a plurality of relative transfer functions (RTFs) to determine the direction of arrival of the emergency vehicle relative to the subject vehicle.
